(19) United States
(12) Patent Application Publication
(10) Pub. No.: US 2026/0201911 A1
(43) Pub. Date: Jul. 16, 2026

(54) MOUNTING AND ADJUSTMENT DEVICE FOR AN ADJUSTMENT ELEMENT OF AN AIRCRAFT, IN PARTICULAR FOR A CONTROL SURFACE, WING TIP OR DOOR OF AN AIRCRAFT

(71) Applicant: Liebherr-Aerospace Lindenberg GmbH, Lindenberg (DE)

(72) Inventors: Markus BILDSTEIN, Oberstaufen (DE); Klaus SCHMELZ, Grünenbach (DE)

(21) Appl. No.: 19/447,300

(22) Filed: Jan. 13, 2026

(30) Foreign Application Priority Data
Jan. 14, 2025 (DE) 10 2025 101 000.5

(51) Int. Cl. F15B 15/14; B64C 9/02; F15B 21/00

(52) U.S. Cl. CPC F15B 15/1447; B64C 9/02; F15B 15/1428; F15B 21/005

(57) ABSTRACT

The disclosure relates to a mounting and adjustment device for an adjustment element of an aircraft, for example for a control surface, pivotable wing tip or door of an aircraft, said mounting and adjustment device comprising a hydraulic cylinder arrangement for performing a linear movement, and a crank mechanism for converting the linear movement into a rotational movement in order to move the adjustment element accordingly. The hydraulic cylinder arrangement comprises a double-acting hydraulic cylinder.

### CROSS REFERENCE TO RELATED APPLICATION

The present application claims priority to German Patent Application No. 10 2025 101 000.5 filed on January 14, 2025. The entire contents of the above-listed application are hereby incorporated by reference for all purposes.

### TECHNICAL FIELD

The present disclosure relates to a mounting and adjustment device for an adjustment element of an aircraft, for example, for a control surface, wing tip or door of an aircraft.

### BACKGROUND & SUMMARY

Such mounting and adjustment devices, such as for mounting and actuating aircraft control surfaces, wing tips or doors, play a central role in modern aviation technology. Particularly in aircraft with thin wings, pivoting wing tips and integrated door mechanisms, optimising weight and space requirements is crucial for the overall performance and efficiency of the aircraft.

In today's aviation industry, lightweight construction and compact designs are becoming increasingly important as they contribute significantly to reducing the overall weight and improving the aerodynamic properties of aircraft. In addition, the reliability and ease of maintenance of hydraulic adjustment devices are of great relevance in order to meet the high safety standards and strict operating conditions of modern aircraft.

According to the prior art, for example as described in DE 102011118321 A1, rotary drives for mounting and actuating aircraft control surfaces are implemented using two single-acting hydraulic cylinders. However, this design leads to increased actuator element weight and volume, as two separate cylinders are required to ensure the necessary freedom of movement and power transmission. In addition, the additional number of components increases the space required, which is particularly problematic given the limited space available on wings and door mechanisms.

The present disclosure therefore aims to overcome the disadvantages of the prior art by providing a mounting and positioning device that significantly reduces both weight and space requirements compared to previous solutions (in particular according to DE 102011118321 A1). This enables more efficient integration into the limited space available in modern aircraft and at the same time contributes to reducing the overall operating costs.

The problems listed above are overcome or at least mitigated by means of a mounting and adjustment device having the features as described herein, or an actuator unit as described herein.

The mounting and adjustment device according to the disclosure for an adjustment element of an aircraft, for example for a control surface, wing tip or door of an aircraft, comprises a hydraulic cylinder arrangement for performing a linear movement, a crank mechanism for converting the linear movement into a rotational movement in order to move the adjustment element accordingly, and is characterised in that the hydraulic cylinder arrangement comprises a double-acting hydraulic cylinder, for example a double-acting hydraulic cylinder.

The present disclosure uses a double-acting hydraulic cylinder, which offers several significant advantages over the prior art. The use of a single double-acting cylinder instead of two single-acting cylinders significantly reduces the overall weight and volume of the actuator, which leads to more efficient use of space, particularly in aircraft with thin wings. In addition, the double-acting cylinder enables a more compact design, as less space is required, which facilitates integration into spatially limited structures. The increased power density and the ability to act in both directions improve the controllability of the aircraft control surfaces and increase the overall performance of the hydraulic system. Furthermore, the reduced number of components compared to prior-art implementations simplifies the design and lowers maintenance requirements, resulting in higher system reliability and lower operating costs. Overall, the use of a double-acting hydraulic cylinder contributes significantly to the optimisation of weight, space requirements, efficiency and costs.

According to an optional development of the present disclosure, the mounting and adjustment device may be designed to simultaneously support and pivot the adjustment element that can be attached to it, optionally without any additional devices.

Furthermore, according to the present disclosure, it may be provided that the hydraulic cylinder arrangement comprises a piston having a piston cup which is in sliding contact with the inside of a housing of the device at its outer circumference and is movable along the axial direction of the housing, a piston pin for connecting the crank mechanism and a piston pin carrier which is arranged in a cup-shaped recess of the piston cup and has a cavity for receiving the piston pin, optionally wherein the piston pin is straight and connects two opposite sides of an inner surface of the cavity of the piston pin carrier, optionally wherein the straight piston pin carrier is aligned perpendicular to the direction of linear movement of the hydraulic cylinder arrangement.

The piston thus consists of several interconnected elements that simplify the assembly of the mounting and adjustment device. A piston cup is provided which has a cup-shaped basic form and a contour on a circumferential portion which is adapted to an inner contour of a housing of the device, so that a sliding contact is created in this circumferential portion which divides the housing into a first chamber and a second chamber of the hydraulic cylinder arrangement. Typically, the piston cup has a radially outwardly extending projection, which is optionally located in the area of the top of the cup.

The piston pin, which typically forms the pivot point for a connecting rod of the crankshaft, is not directly connected to the piston cup. A piston pin carrier is arranged between the piston pin and the piston cup and is secured in the cup-like recess of the piston cup.

The piston pin carrier itself also has a cavity in which the piston pin is located. The piston pin carrier is connected to the piston cup on the outside of the element of the piston pin carrier that creates the cavity. An example of this connection could be a threaded connection, so that the piston pin carrier has a circumferential external thread on its outer circumference that interacts with an internal thread in the cup-like recess of the piston cup.

The side wall of the piston cup extends parallel to the linear movement of the hydraulic cylinder arrangement, wherein the base of the piston cup can be arranged in a normal plane to the direction vector of the linear movement.

The threaded portion running along the inner circumference of the side wall of the piston cup therefore allows the piston pin carrier to be fastened in such a way that it is fixed to the piston cup in the direction of linear movement (axial direction).

As already explained, it may also be provided that the piston cup is provided with an internal thread on the inside of its cup-shaped recess and the piston pin carrier has a matching external thread on its outside, so that the piston pin carrier is fixed to the piston cup via a threaded connection, optionally fixed in the axial direction of the device.

According to a further optional modification of the present disclosure, it may be provided that the piston cup divides the housing fluidically into a first piston chamber and a second piston chamber, each of which is provided with a port for introducing and/or discharging a fluid.

By introducing pressurised fluid, for example hydraulic oil, the volume of one of the two chambers is increased and, at the same time, the volume of the other chamber is reduced accordingly.

According to a further optional development of the present disclosure, it may be provided that the piston cup has at least one groove (optionally extending radially to the axial direction) for inserting at least one sliding piece, which is in sliding contact with the inside of the housing, for example a cover portion of the housing, optionally with several grooves arranged opposite each other in the circumferential direction with respective sliding pieces.

The advantage of the grooves provided in the cup base region of the piston cup lies in the improved stability and guidance of the piston within the housing. The insertion of sliding pieces that are in sliding contact with the inside of the housing, for example a cover portion, achieves an even distribution of force. In addition, several oppositely arranged grooves with respective sliding pieces increase the symmetry and balance of the system, which reduces the wear rate of the moving parts and extends the overall service life of the device. Furthermore, the improved guidance contributes to a reduction in friction and energy losses, which further increases the efficiency of the hydraulic system.

According to a further optional modification of the present disclosure, the piston pin may not have a hydraulic seal.

A seal on the piston pin may be omitted due to the arrangement on the piston pin carrier.

According to a further optional modification of the present disclosure, the crank mechanism may comprise a connecting rod connected to the hydraulic cylinder arrangement and a crankshaft connected to an end region of the connecting rod spaced apart from the hydraulic cylinder arrangement in order to convert the linear movement executable by the hydraulic cylinder arrangement into a rotational movement.

The connecting rod may have a recess that surrounds the piston pin circumferentially, optionally along the entire circumferential side.

According to a further optional development of the present disclosure, the device may have several fastening recesses for fastening to a rigid element, which are arranged in a first plane, and respective connections to the different chambers of the double-acting hydraulic cylinder are arranged in a second plane, which is parallel or identical to the first plane.

These fastening recesses serve to guide a fastening means, for example a screw or a bolt, and are typically aligned with corresponding bores or recesses in a rigid component of an actuator unit in order to fasten the mounting and adjustment device to it. For particularly easy attachment to this rigid component, at least one of the connections for the different chambers of the double-acting hydraulic cylinder may be arranged in a plane that is parallel to the plane in which the multiple fastening recesses are located.

This ensures that when the mounting and adjustment device is attached to a rigid element, a connection to at least one of the two connections for a respective chamber of the double-acting cylinder is also connected or inserted at the same time.

Since it is therefore no longer necessary to perform separate work steps for this purpose, the assembly time is reduced and the mounting and adjustment device can be operated more economically.

The present disclosure also relates to an actuator unit for an adjustment element of an aircraft, for example for a control surface, a wing tip or a door of an aircraft, which comprises a mounting and adjustment device according to one of the aspects discussed above, a first hydraulic line for connecting to a first chamber of the double-acting hydraulic cylinder and a second hydraulic line for connecting to a second chamber of the double-acting hydraulic cylinder, wherein the first hydraulic line and the second hydraulic line are arranged parallel to each other in their attachment region to the mounting and adjustment device, for example orthogonally to an axis of rotation of the rotational movement generated by the crank mechanism.

The parallel arrangement of the two hydraulic lines makes it possible to generate the application of the different chambers of the double-acting hydraulic cylinder with only one movement of the mounting and adjustment device, since the attachment region runs parallel. If it is also provided that the fastening recesses for connecting the mounting and adjustment device to a rigid component of the actuator unit have a fastening means which is parallel to the direction of the hydraulic lines in the attachment region, the fastening effect for fixing the mounting and adjustment device to the rigid element can simultaneously cause the two hydraulic lines to be connected in a fluid-tight manner in a respective attachment region of the mounting and adjustment device. This also reduces the number of steps required to assemble the actuator unit.

Optionally, it may be provided that the first hydraulic line and the second hydraulic line establish a fluid-tight connection to a respective corresponding connection of a chamber of the double-acting hydraulic cylinder by means of a plug connection, optionally without additional means for axially fixing the first hydraulic line or the second hydraulic line, such as a union nut or the like.

By implementing a plug connection from the attachment region of the two hydraulic lines, the fastening step of the mounting and adjustment device to a rigid component of the actuator unit simultaneously also becomes a connection step of the respective hydraulic line to the corresponding chamber of the double-acting hydraulic cylinder.

Furthermore, according to an optional modification of the present disclosure, it may be provided that several mounting and adjustment devices are provided which can be controlled via the first hydraulic line and the second hydraulic line, optionally wherein the first hydraulic line and/or the second hydraulic line are hydraulically connected in parallel to the several mounting and adjustment devices.

For example, it may be provided that the respective attachment regions of the hydraulic lines for interaction with a respective chamber of the plurality of double-acting cylinders provided are all aligned parallel to each other and that hydraulic connecting lines are provided which connect the plurality of attachment regions of the hydraulic lines to each other. These connecting lines may run orthogonally to the alignment of the attachment regions of the hydraulic lines. Furthermore, it may be provided that the connecting lines have a larger cross-section than the lines in the attachment region, which are distinguished in that they run vertically or at least form an angle with the connecting lines.

According to a further advantageous modification of the present disclosure, it may be provided that, in order to synchronise the rotational movement of the plurality of mounting and adjustment devices, the adjustment element connecting the mechanical connections of the plurality of mounting and adjustment devices to one another is used, wherein the adjustment element optionally has a torsionally rigid portion which connects the mechanical connections of the plurality of mounting and adjustment devices to one another and is for example tubular in design.

The adjustment element is the part that is movable relative to the rigid element and can be pivoted by means of the mounting and adjustment device.

According to a further optional modification of the present disclosure, it may be provided that the adjustment element actuated by the mounting and adjustment device is an aircraft control surface, a wing tip or a door.

The disclosure also relates to an aircraft with a mounting and adjustment device according to one of the aspects discussed above or an actuator unit according to one of the aspects discussed.

### BRIEF DESCRIPTION OF THE FIGURES

Further features, details and advantages of the disclosure will become apparent from the following description of the figures, in which:

FIG. 1: shows a sectional view of the mounting and adjustment device according to the disclosure integrated into a wing of an aircraft,

FIG. 2: shows a perspective view of FIG. 1,

FIG. 3: shows a perspective view of FIG. 1 without the adjustment element,

FIG. 4: shows a representation of two mounting and adjustment devices arranged side by side,

FIG. 5: shows a perspective view of the rigid element of an aerofoil that interacts with a mounting and adjustment device,

FIG. 6: shows a partial sectional view of the rigid element of the wing to show the connections of the hydraulic lines,

FIG. 7: shows a partially transparent representation of the wing for better illustration of a torsion-resistant element,

FIG. 8: shows a sectional view along the longitudinal axis of the mounting and adjustment device integrated into the aerofoil,

FIG. 9: shows a sectional view along B – B from FIG. 8, and

FIG. 10: shows a sectional view along A–A from FIG. 8

### DETAILED DESCRIPTION

FIG. 1 shows a detail of an aerofoil 1 of an aircraft, which comprises an adjustment element 2 and a rigid element 3. The adjustment element 2 and the rigid element 3 are connected to each other by means of a mounting and adjustment device 4 according to the disclosure, wherein the adjustment element 2 can be pivoted relative to the rigid element 3 in order to vary the aerodynamic properties of the wing 1. Although the present disclosure is described by way of example using control surfaces of wings, it is also applicable to control surfaces of other aerodynamically effective geometries of aircraft, such as elevators and ailerons, to movable wing tips, and to doors of an aircraft.

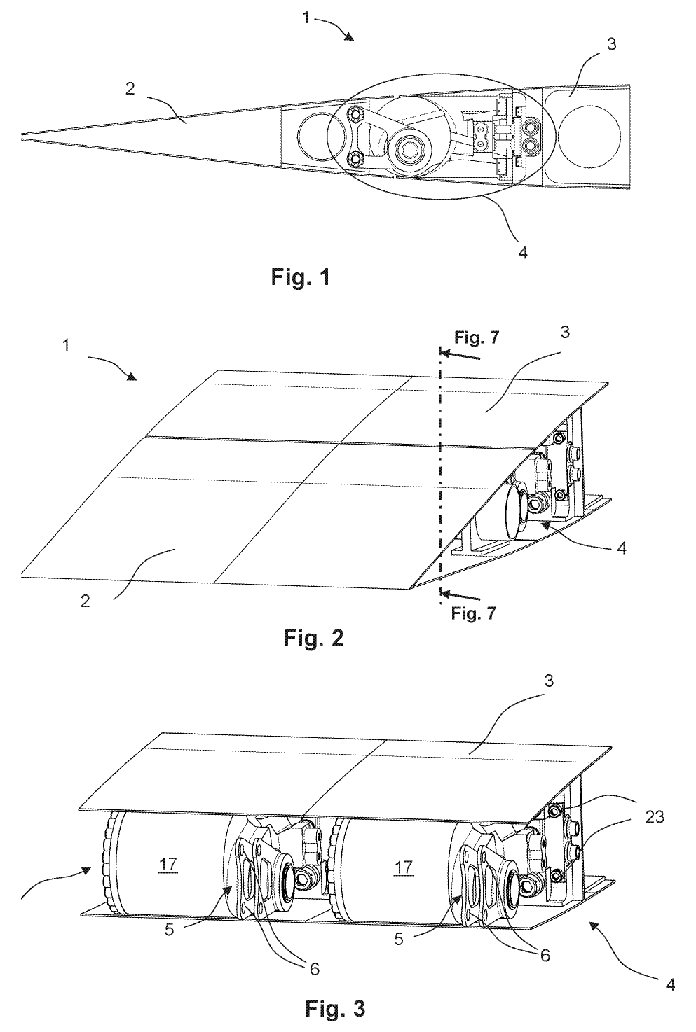

FIGS. 2-7 show spatial views of the wing detail according to FIG. 1 to explain the integration of the mounting and adjustment device 4 into the wing, wherein certain components have been omitted in the various figures for the sake of clarity.

FIG. 2 shows FIG. 1 in a spatial representation. This view illustrates the three-dimensional integration of the mounting and adjustment device 4 into the wing 1 of the aircraft and provides a better understanding of the positioning and connection of the individual components within the wing 1.

FIG. 3 shows FIG. 2 without the adjustment element 2, revealing the two mounting and adjustment devices 4 arranged next to each other. These mounting and adjustment devices 4 are attached to the rigid element 3, for example by means of fastening screws 23, which attach a respective device 4 to the rigid element 3.

Only two mounting and adjustment devices 4 are shown, but depending on the length of the wing and the loads on the adjustment elements 2, several mounting and adjustment devices 4 may also be required. The adjustment element 2 is fastened to the two rotary outputs 5, for example by means of four bolt, rivet or screw connections, which use the mounting holes 6.

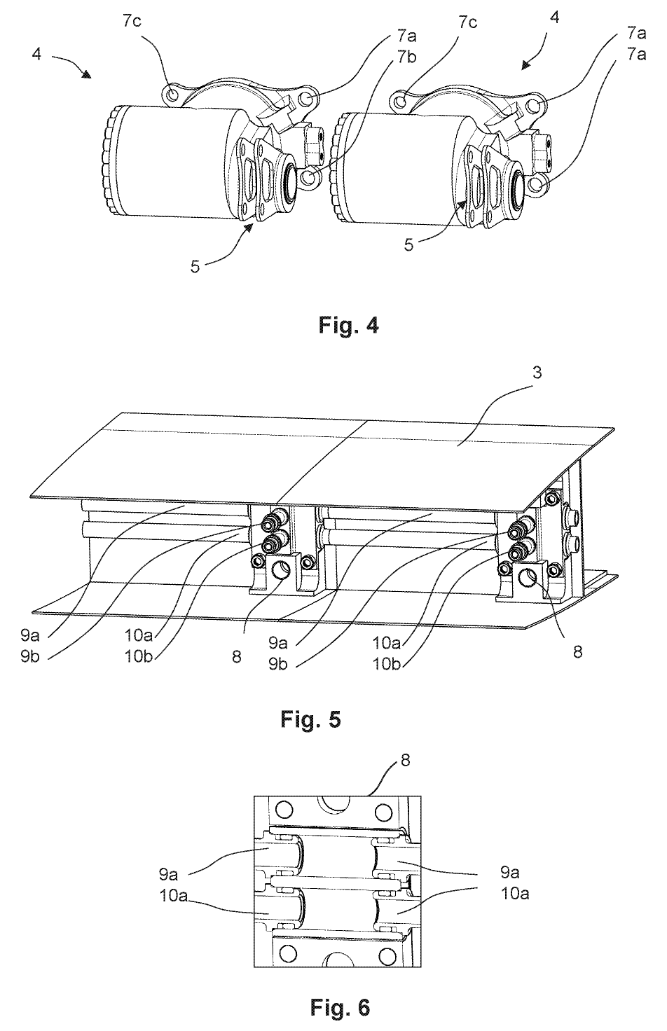

FIG. 4 shows the two mounting and adjustment devices arranged next to each other without the rigid element 3, which is still shown in FIG. 3. These devices 4 are attached to the rigid element 3, for example, by means of screw connections 23 (see FIG. 3), which use the fastening recesses 7a and 7b of the device 1 for fastening. The forces acting on the adjustment element 2 are mainly transmitted by the screw connections 23, which are located substantially in the same plane as the rotary output 5 or the bolt connections in the mounting holes 6. The screw connection 7c, which deviates laterally from this, mainly serves to increase the lateral attachment stiffness.

FIG. 5 shows only the rigid element 3, on which the multiple mounting and adjustment devices 4 are to be arranged in order to pivotably mount and adjust an adjustment element relative to the rigid element 3 via the rotary output 5. The illustration shows the hydraulic lines 9a, 9b, 10a, 10b, which may be configured, for example, as pressure-compensated, pluggable pipes with elastomer sealing rings. This implementation reduces the space required, as it eliminates the need for union nuts, which are commonly used for hydraulic piping, particularly in the attachment region of the mounting and adjustment device 4.

The first hydraulic line 9a, 9b and the second hydraulic line 10a, 10b connect the respective chambers 18a, 18b of the mounting and adjustment devices 4 to the hydraulic control unit (not shown), wherein the attachment regions 9b, 10b of the first hydraulic line and the second hydraulic line are designed parallel to each other and are aligned orthogonally to the pivot axis of the rotary output 5.

The respective attachment region 9b, 10b of the two hydraulic lines, which interact with one of the two chambers of the double-acting hydraulic cylinder 21, can be aligned perpendicular to a connection portion 9a, 10a of the hydraulic line, which serves to connect several mounting and adjustment devices 4 positioned next to each other in a hydraulic parallel connection. The connection portions 9a, 10a may have a larger diameter than the attachment regions 9b, 10b so that they are able to supply fluid to several mounting and adjustment devices 4 and do not exhibit an excessive pressure loss when a mounting and adjustment device 4 is attached.

Furthermore, FIG. 5 shows fastening recesses 8 at the rigid end 3 of the screw connections 23 in FIG. 3, which serve to fasten the mounting and adjustment device 4 to the rigid end 3. The fastening recesses 8 may be provided with an internal thread for fastening by means of a screw. However, it is also conceivable that the fastening recesses 8 are merely a through-hole, so that the mounting and adjustment device 4 can be secured by means of a screw and nut. A person skilled in the art is aware that alternative fastening devices are possible for arranging the mounting and adjustment device 4 on the rigid element 3.

As shown in FIG. 6, several mounting and adjustment devices 4 can be connected to several hydraulic lines 9a, 9b, 10a and 10b. The hydraulic lines 9a and 10a have a larger flow diameter than 9b and 10b in order to keep the pressure loss within reasonable limits.

It can be seen that the hydraulic lines, optionally hydraulic pipes, can be integrated into the overall system by simply plugging them into the distributor arrangement shown.

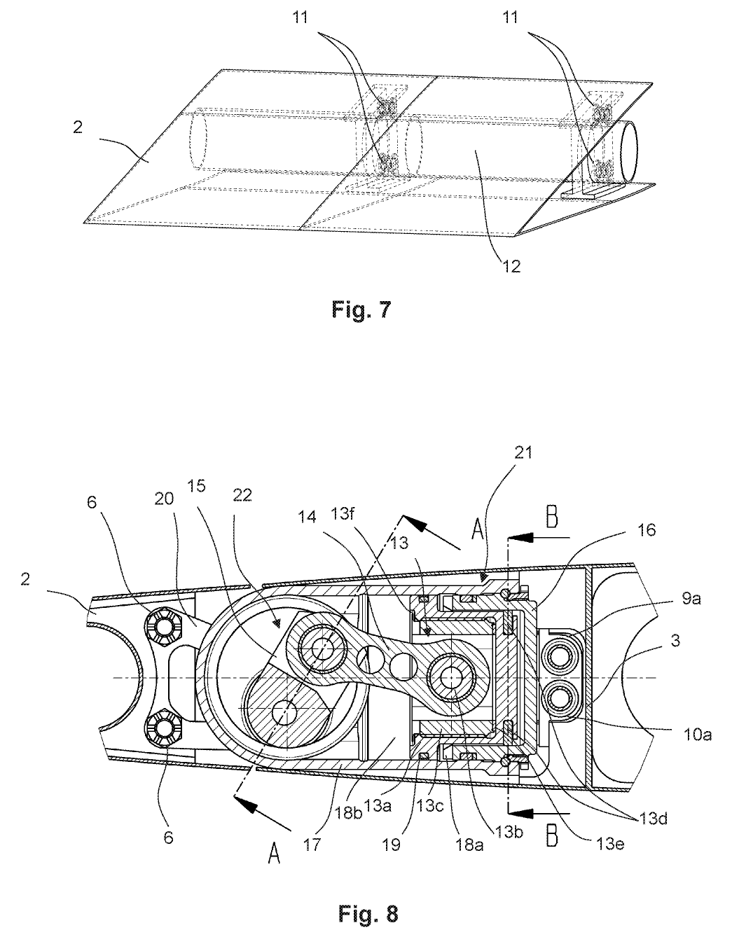

FIG. 7 shows the adjustment element 2, in which the concealed component edges are shown with dashed lines. The adjustment element 2 is connected to the two mounting and adjustment devices 4 by means of the mechanical connection 11 (also called: interface). To ensure that the mounting and adjustment devices 4 run synchronously, the mechanical connections 11 are connected to each other by means of a torsion-resistant portion 12, shown as a pipe 12 in the example. This connection ensures uniform movement and increases the stability of the adjustment element 2 during actuation and when loads are being supported.

FIG. 8 shows the structural set-up of the mounting and adjustment device 4. A crank mechanism 22 with a piston 13, a connecting rod 14 and a crankshaft 15 can be seen. The piston 13 comprises the piston cup 13a, the piston pin 13b, the piston pin carrier 13c, the sliding pieces 13d, an adjustment disc 13e and a securing arrangement 13f. The piston pin carrier 13c and the piston cup 13a are connected to each other by means of a thread, wherein the piston pin 13b is fixed in its axial position on the piston cup 13a by the piston cup 13a. The securing arrangement 13f prevents the thread from loosening, for example by plastically deforming a thin-walled end of the thread into a local recess in the piston cup 13a.

The piston 13 of the double-acting hydraulic cylinder 21 can move axially back and forth in a housing 17. In addition, the piston 13 with its piston cup 13a divides the housing 17 (including the cover 16) into a first chamber 18a and a second chamber 18b. Regardless of the position of the piston 13 in the housing 17, each of the two chambers 18a, 18b is fluidically connected exclusively to one of the two hydraulic lines 9a, 10a, so that the piston 13 can be moved in its axial direction by adding and, correspondingly, removing fluid through the hydraulic lines 9a, 10a.

This movement causes the connecting rod 14 and the crankshaft 15 to pivot correspondingly the rotary output arm 20, to which the adjustment element 2 is attached via corresponding fastening elements 6. If the piston 13 is lifted, the adjustment element 2 is deflected correspondingly from its position shown in FIG. 8.

An advantage of using the double-acting hydraulic cylinder 21 is that even in the very confined space, such as that found in a wing, the diameter of the cylinder can occupy almost the entire available installation space, so that the required pressures are reduced or the available force is increased.

It can also be seen that the piston 13 comprises a piston cup 13a, which has a piston seal 19 on the circumference in a portion of its largest diameter in order to fluidically separate the first chamber 18a from the second chamber 18b of the hydraulic cylinder 21. The connecting rod 14 is also connected to the piston 13 via a piston pin 13b.

For example, all rotatable connections in the mounting and adjustment device 4 are designed as plain bearings, but roller bearings are also possible. Roller bearings increase the efficiency of the mounting and adjustment device 4 and reduce the hysteresis of the adjustment process, but they require more installation space and add extra weight.

The piston pin 13b is not directly attached to the piston cup 13a, but instead contacts a piston pin carrier 13c. This piston pin carrier 13c can, for example, have the basic structure of a cylinder with a thread on its outer circumferential surface. This thread can be engaged with an internal thread formed on the inside of the piston cup 13a. This fixes the piston pin 13b axially to the piston cup 13a.

The housing cover 16 has a U-shaped cross-section and has at least one circumferential sealing element on its outer side, so that a sealing closure can be achieved by inserting it into a suitably dimensioned extension of the housing 17.

There are grooves in the base region of the piston cup 13a which accommodate the sliding pieces 13d. The sliding pieces 13d introduce an additional degree of freedom into the crank mechanism kinematics in order to allow for greater manufacturing tolerances for the kinematics-defining components. For kinematic reasons, the sliding pieces 13d must be positioned as shown in FIG. 8, e.g., the threaded connection must assume the required rotational position after the tightening torque has been applied. To achieve this, the thickness of the adjustment disc 13e is manufactured accordingly in advance.

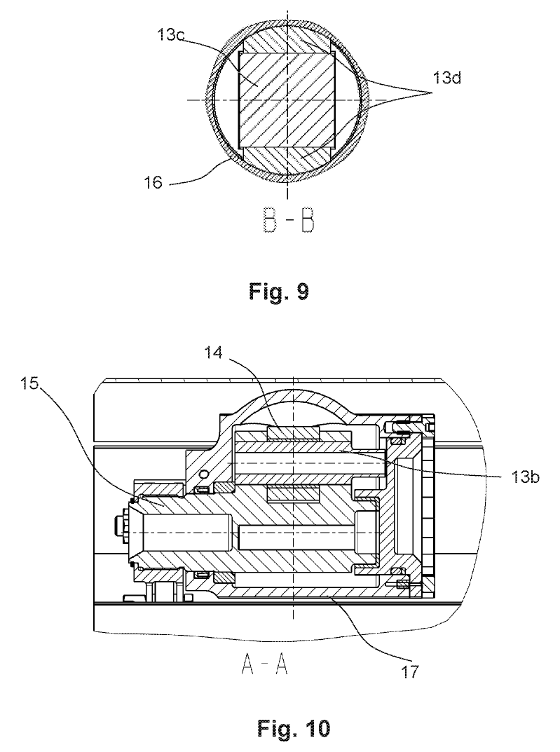

In FIG. 9, the view corresponding to B-B from FIG. 8, it can be seen that the sliding pieces 13d allow the end of the piston cup 13a, the cup base region which accommodates the sliding pieces 13d, to move horizontally and to be supported vertically in the bore of the cover 16. This ensures that the piston 13 can align itself with the varying position of the piston-receiving cover 16 and the housing 17 due to manufacturing tolerances of all kinematics-defining components, thereby ensuring the mountability of the crank mechanism 22 and its free movement under load.

FIG. 10 shows the view corresponding to A-A in FIG. 8 and shows the crankshaft 15 and the connection between the connecting rod 14 and the piston pin 13b.

### List of Reference Signs:

1 aircraft wing / actuator unit

2 adjustment element

3 rigid element

4 mounting and adjustment device

5 rotary output

6 mounting hole

7 fastening recesses

8 fastening recesses on the rigid element

9a first hydraulic line

9b attachment region of the first hydraulic line

10a second hydraulic line

10b attachment region of the second hydraulic line

11 mechanical connection / interface

12 torsion-resistant portion, e.g. pipe

13 piston

13a piston cup

13b piston pin

13c piston pin carrier

13d sliding pieces

13e adjustment disc

13f securing arrangement

14 connecting rod

15 crankshaft

16 cover

17 housing

18a first chamber

18b second chamber

19 piston seal

20 rotary output arm

21 hydraulic cylinder arrangement / double-acting hydraulic cylinder

22 crank mechanism

1. A mounting and adjustment device for an adjustment element of an aircraft, said mounting and adjustment device comprising:
a hydraulic cylinder arrangement for performing a linear movement, and
a crank mechanism for converting the linear movement into a rotational movement in order to move the adjustment element accordingly,
wherein the hydraulic cylinder arrangement comprises a double-acting hydraulic cylinder.

2. The mounting and adjustment device according to claim 1, wherein the mounting and adjustment device is designed to simultaneously support and pivot the adjustment element.

3. The mounting and adjustment device according to claim 1, wherein the hydraulic cylinder arrangement comprises a piston having:
a piston cup which is in sliding contact with an inside of a housing of the mounting and adjustment device at its outer circumference and is movable along an axial direction of the housing,
a piston pin for connecting the crank mechanism, and
a piston pin carrier which is arranged in a cup-shaped recess of the piston cup and has a cavity for receiving the piston pin.

4. The mounting and adjustment device according to claim 3, wherein the piston cup is provided with an internal thread on an inside of its cup-shaped recess and the piston pin carrier has a matching external thread on its outside, so that the piston pin carrier is fixed to the piston cup via a threaded connection.

5. The mounting and adjustment device according to claim 3, wherein the piston cup divides the housing fluidically into a first piston chamber and a second piston chamber, each of which is provided with a port for introducing and/or discharging a fluid.

6. The mounting and adjustment device according to claim 3, wherein the piston cup has at least one groove for inserting a sliding piece, which is in sliding contact with the inside of the housing.

7. The mounting and adjustment device according to claim 3, wherein the piston pin does not have a hydraulic seal.

8. The mounting and adjustment device according to claim 1, wherein the crank mechanism comprises:
a connecting rod connected to the hydraulic cylinder arrangement, and
a crankshaft connected to an end region of the connecting rod spaced apart from the hydraulic cylinder arrangement in order to convert the linear movement executable by the hydraulic cylinder arrangement into the rotational movement.

9. The mounting and adjustment device according to claim 1, wherein:
the mounting and adjustment device has several fastening recesses for fastening to a rigid element, which are arranged in a first plane, and
at least one connection to different chambers of the double-acting hydraulic cylinder are arranged in a second plane, which is parallel or identical to the first plane.

10. An actuator unit for an adjustment element of an aircraft, said actuator unit comprising:
the mounting and adjustment device according to claim 1,
a first hydraulic line for connecting to a first chamber of the double-acting hydraulic cylinder, and
a second hydraulic line for connecting to a second chamber of the double-acting hydraulic cylinder,
wherein the first hydraulic line and the second hydraulic line are arranged parallel to each other in their attachment region to the mounting and adjustment device.

11. The actuator unit according to claim 10, wherein the first hydraulic line and the second hydraulic line establish a fluid-tight connection to a respective corresponding connection of a chamber of the double-acting hydraulic cylinder by means of a plug connection.

12. The actuator unit according to claim 10, wherein several mounting and adjustment devices are provided which can be controlled via the first hydraulic line and the second hydraulic line.

13. The actuator unit according to claim 12, wherein, in order to synchronise the rotational movement of the several mounting and adjustment devices, the adjustment element mechanically connects the several mounting and adjustment devices to one another.

14. The actuator unit according to claim 10, wherein the adjustment element actuated by the mounting and adjustment device is an aircraft control surface, at least one aileron, at least one elevon, at least one rudder, at least one spoiler, or at least one wing tip.

15. An aircraft with the mounting and adjustment device according to claim 1.

16. The mounting and adjustment device according to claim 1, wherein the adjustment element of the aircraft is a control surface, a wing tip, or a door of the aircraft.

17. The mounting and adjustment device according to claim 1, wherein the hydraulic cylinder arrangement consists of the double-acting hydraulic cylinder.

18. The mounting and adjustment device according to claim 2, wherein the mounting and adjustment device is designed to simultaneously support and pivot the adjustment element without any additional devices.

19. The mounting and adjustment device according to claim 3, wherein the piston pin is straight and connects two opposite sides of an inner surface of the cavity of the piston pin carrier.

20. The mounting and adjustment device according to claim 19, wherein the straight piston pin carrier is aligned perpendicular to the direction of linear movement of the hydraulic cylinder arrangement.
